(19) United States
(12) Patent Application Publication
(10) Pub. No.: US 2006/0187377 A1
(43) Pub. Date: Aug. 24, 2006

(54) Optical sheet having anisotropic light diffusing characteristic and surface illuminant device including the same

(75) Inventors: Jae-ho You, Seoul (KR); Hwan-young Choi, Anyang-si (KR); Jin-hwan Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/357,133

(22) Filed: Feb. 21, 2006

(30) Foreign Application Priority Data
Feb. 18, 2005 (KR) 10-2005-0013530

(51) Int. Cl. G02F 1/1335

(52) U.S. Cl. 349/64

(57) ABSTRACT

A light sheet including: a substrate layer including a transparent matrix; and an anisotropic light diffusing layer including an array of elliptical lenses arranged on a first surface of the substrate layer. The anisotropic light diffusing layer anisotropically scatters light that is input therein, before transmitted it to the substrate.

### CROSS-REFERENCE TO RELATED PATENT APPLICATIONS

This application is based upon and claims the benefit of priority from Korean Patent Application No. 10-2005-0013530, filed on Feb. 18, 2005, in the Korean Intellectual Property Office, the disclosure of which is incorporated herein in its entirety by reference.

### BACKGROUND OF THE INVENTION

1. Field of the Invention

Devices, systems, and methods consistent with the invention relate to surface illumination, and more particularly, to receiving light emitted from a surface illuminant device, anisotropically diffusing the received light, and outputting the diffused light.

2. Description of the Related Art

A plane display device such as a liquid crystal display (LCD) device includes a surface illuminant device at a rear surface of a display panel. To improve distribution of luminance of light at the front surface of the display panel, an optical sheet such as a diffusing sheet, a prism sheet, or a luminance improving sheet is provided between a surface illuminant device and the display panel.

FIG. 1 is a section view of a related-art light diffusing sheet used for a surface illuminant device. FIGS. 2A and 2B are views for explaining the effect of the light diffusing sheet used for the related-art surface illuminant device.

Referring to FIG. 1, a related-art surface illuminant device includes a light guide plate 10 guiding plane light. The light guide plate 10 guides light emitted from a light source 11 (e.g., an LED light source) to output plane light. The light is guided by being totally reflected in the light guide plate 10.

For this purpose, a unit for diffraction and diffusion of the plane light (e.g., a first hologram layer including a grating or a reflecting sheet for reflection of light) may be provided at a lower surface of the light guide plate 10. Also, a second hologram layer including other grating to guide the plane light to be output from the light guide plate 10 may be provided at the upper surface of the light guide plate 10. Also, prism sheets to improve the characteristics of the light output from the light guide plate 10 may further be provided over the front surface of the light guide plate 10. These layers and/or sheets are formed, attached, or deposited on the light guide plate 10 to constitute a hologram light guide panel system.

In the hologram light guide panel system, a light diffusing sheet 20 for improving the characteristics of light by diffusing the light output from the hologram light guide plate 10 is attached on the front surface of the light guide plate 10. The light output from the light guide plate 10 and incident on the light diffusing sheet 20 may be an anisotropic beam having a substantially anisotropic luminance distribution characteristic, as discussed below.

In FIGS. 1 and 2A, an X direction is a direction of an optical axis of the light source 11 provided at the side of the light guide plate 10, a Y direction is perpendicular to the X direction, and a Z direction is a direction along which light is emitted from the light guide plate 10. The angular distribution of the light emitted from the light guide plate 10 may have an anisotropic characteristic due to a diffraction and/or focusing structure of the light guide plate 10. That is, as shown in FIG. 2A, the light luminance distribution in the X direction and that in the Y direction may differ from each other. For example, the the second hologram provided on the upper surface of the light guide plate 10 may be provided in a format of line-type grooves repeating and extending in the Y direction. Accordingly, the light output from the light guide plate 10 may have an anisotropic light intensity angular distribution extending in the Y direction as shown in FIG. 2A.

However, the related-art light diffusing sheet 20 provided at the front surface of the light guide plate 10 has an isotropic angular distribution character so that the same diffusing character is exhibited in both X and Y directions. As shown in FIG. 1, in the related-art light diffusing sheet 20, a light diffusing layer 23 in the form of a plurality of beads 24 is formed on the front surface of a substrate 21, which is a transparent matrix. An anti-blocking layer 27 having an embossed structure to improve attachment and/or detachment is formed on the rear surface of the substrate 21. The light diffusing layer 23 diffuses incident light by dispersing the light using the beads 24 included in the light diffusing layer 23. Further, the light diffusing layer 23, as a random surface, exhibits an isotropic diffusing angular distribution characteristic in which the diffusing angular distributions in the X direction and the Y direction with respect to an exit light Z axis are identical.

Thus, the light exiting from the light diffusing sheet 20 is emitted with an anisotropic diffusing light intensity according to the anisotropic diffusing characteristic of the light output from the light guide plate 10. That is, as shown in FIG. 2B, in the light output from the light diffusing sheet 20, a light luminance angular distribution curve 31 in the X direction is different from a light luminance angular distribution curve 35 in the Y direction. Thus, since light incident on a display panel arranged on the front surface of the light diffusing sheet 20 (e.g., a LCD panel) has an anisotropic light distribution, it is expected that the display quality of the display panel is deteriorated and/or luminance and visibility according to an angle are deteriorated.

Therefore, to improve the quality of the display panel, the development of a light diffusing sheet capable of adjusting the anisotropic light distribution of the light output from the light guide plate 10 is needed.

### SUMMARY OF THE INVENTION

To solve the above and/or other problems, the invention provides an optical sheet having an anisotropic light diffusing characteristic, and which is capable of outputting light by adjusting an optical angular distribution of incident light input from a surface light source, and a surface illuminant device including the same.

According to an aspect of the invention, an optical sheet is provided, having an anisotropic light diffusing characteristic and including a substrate layer of a transparent matrix and an anisotropic light diffusing layer having an array of elliptical lenses arranged on a surface of the substrate layer to anisotropically diffusing light that is incident and passes.

According to another aspect of the invention, a light sheet comprises a substrate layer which is a transparent matrix, and an anisotropic light diffusing layer including an array of a plurality of elliptical lenses arranged on a surface of the substrate layer to anisotropically scatter light that is input and transmitted.

According to another aspect of the invention, the anisotropic light diffusing layer anisotropically scatters the transmitting light by depending on lengths of major and minor axes of each of the elliptical lenses such that light diffusing angular distributions in directions along the major axis and the minor axis are different from each other.

According to another aspect of the invention, the elliptical lenses of the anisotropic light diffusing layer are arranged parallel to one another in the direction along the major axis or the minor axis of each elliptical lens.

According to another aspect of the invention, the elliptical lenses of the anisotropic light diffusing layer are engraved on a surface of the substrate layer.

According to another aspect of the invention, the light sheet further comprises an isotropic light diffusing layer which is formed on the other surface of the substrate layer to isotropically scatter the transmitting light.

According to another aspect of the invention, a light sheet comprises a substrate layer which is a transparent matrix, and an anisotropic light diffusing layer including an array of a plurality of elliptical lenses engraved on a surface of the substrate layer to anisotropically scatter light that is input and transmitted.

According to another aspect of the invention, the light sheet further comprises an isotropic light diffusing layer, which is deposited on the other surface of the substrate layer as a thin layer to isotropically scatter the transmitting light.

According to another aspect of the invention, a surface illuminant device comprises a light source, a light guide plate guiding light generated from the light source, and a light sheet provided on the light guide plate and including a substrate layer which is a transparent matrix, and an anisotropic light diffusing layer including an array of a plurality of elliptical lenses arranged on a surface of the substrate layer to anisotropically scatter light that is input and transmitted.

### BRIEF DESCRIPTION OF THE DRAWINGS

The above and/or other aspects of the invention will become more apparent by describing in detail exemplary embodiments of the invention with reference to the attached drawings, in which:

FIG. 1 is a sectional view of a light diffusing sheet employed in a related-art surface illuminant device;

FIGS. 2A and 2B are a perspective view and a graph for explaining an isotropic light diffusing characteristic of the light diffusing sheet employed in a related-art surface illuminant device;

FIG. 3 is a sectional view of an anisotropic light diffusing sheet employed in a surface illuminant device according to an exemplary embodiment of the invention;

FIG. 4 is a view illustrating an example of an array of elliptical lenses employed in the anisotropic light diffusing sheet according to an exemplary embodiment of the invention;

FIG. 5 is a graph for explaining an anisotropic diffusing characteristic by the elliptical lenses according to an exemplary embodiment of the invention; and

FIG. 6 is a view for explaining the effects of the introduction of the elliptical lens array according to an exemplary embodiment of the invention.

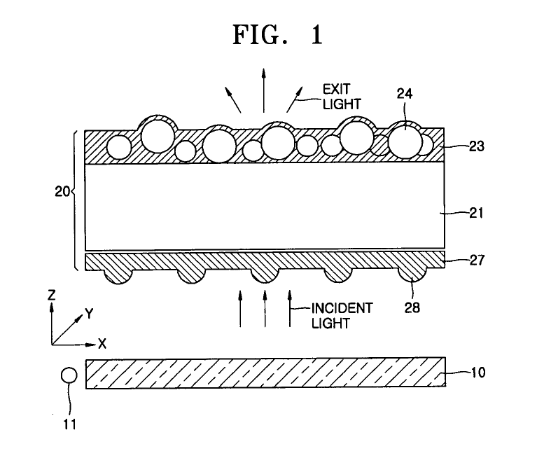

### DETAILED DESCRIPTION OF EXEMPLARY EMBOIDMENTS

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

In an exemplary embodiment of the invention, an anisotropic light diffusing sheet having an elliptical lens array layer is provided, which exhibits an anisotropic light diffusing characteristic to adjust an angular distribution of luminance of exit light by changing the angular distribution of luminance of incident light in an anisotropic manner. The elliptical lens array layer can be formed in various ways. As a matter of example, the elliptical lens array layer may be formed on a transparent polymer matrix (e.g., PMMA (polymethyl methacrylate)), in a stamp method or by using a roller. The elliptical lens or the elliptical lens array scatters or refractively diffuses incident light in different light distributions according to an angle θ along the major axis and minor axis of the elliptical lens, which are set to have different lengths.

The anisotropic light diffusing sheet can adjust the anisotropic characteristic of the exit light (e.g., the diffusing angular distribution of the exit light and/or the luminance angular distribution) in view of the geometric shape of the elliptical lens and/or elliptical lens array. Thus, since the anisotropic light distribution produced by the waveguide can be adjusted through the anisotropic diffusing characteristic of the light diffusing sheet according to an exemplary embodiment of the invention, the luminance of a display panel assembled on the light diffusing sheet can be improved and/or visibility according to an angle and/or the quality of display can be improved.

Also, the anisotropic light diffusing sheet can be manufactured in a relatively simple method such as the stamp method or by using the roller. Also, since the light diffusing sheet has a sheet shape, it can be relatively simply attached to the waveguide so as to be assembled to a surface illuminant device.

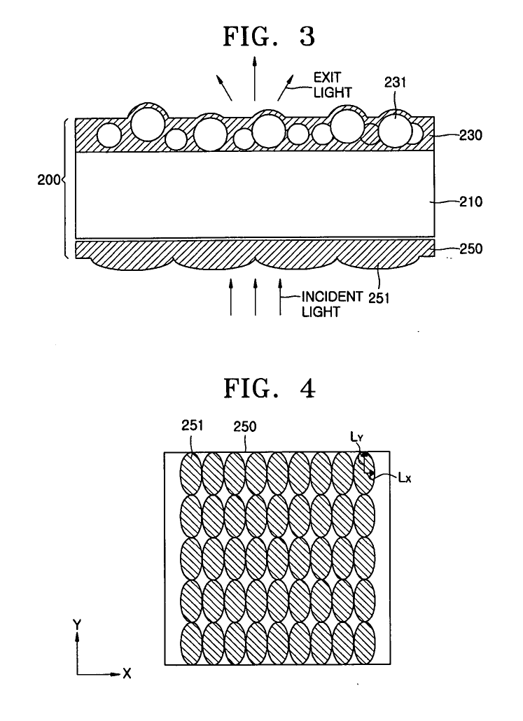

FIG. 3 is a sectional view of an anisotropic light diffusing sheet employed in a surface illuminant device according to an exemplary embodiment of the invention. FIG. 4 is a view illustrating an example of an array of elliptical lenses employed in the anisotropic light diffusing sheet according to an exemplary embodiment of the invention.

Referring to FIG. 3, an anisotropic light diffusing sheet 200 according to an exemplary embodiment of the invention includes an anisotropic light diffusing layer 250, on a surface of a substrate 210, where the substrate is a transparent base matrix. The anisotropic light diffusing layer 250 includes an elliptical lens array layer formed on a transparent base matrix. The lens density of the array of a plurality of elliptical lenses 251 can be uniform throughout the entire area of the anisotropic light diffusing layer 250, or can be formed differently for each area according to a demand.

The anisotropic light diffusing sheet 200 according to an exemplary embodiment of the invention can be manufactured in the form of a sheet and/or film of a polymer material. For example, after a shape of an elliptical lens array has been provided on a roller, a transparent polymer film (e.g., a PMMA film) may be surface-processed using the roller so that the anisotropic light diffusing layer 250 having an elliptical lens array can be formed or engraved. Alternatively, the anisotropic light diffusing layer 250 may be formed directly on substrate 210 when the substrate 210 is processed using the roller. Thus, the anisotropic light diffusing sheet 200, according to an exemplary embodiment of the invention, has the benefit of using a related-art polymer sheet surface processing method in its processing.

An isotropic light diffusing layer 230 for isotropically diffusing incident light may be formed on a surface of the substrate 210 opposite the anisotropic light diffusing layer 250 (e.g., a front surface of the substrate 210). The isotropic light diffusing layer 230 can be implemented as a layer including a plurality of beads 231. Such a bead type isotropic light diffusing layer 230 may be formed on the substrate 210 by sprinkling the beads 231 on a front end of the roller so that the beads 231 can be buried in the surface of the substrate 210 when a sheet is surface-processed using the roller.

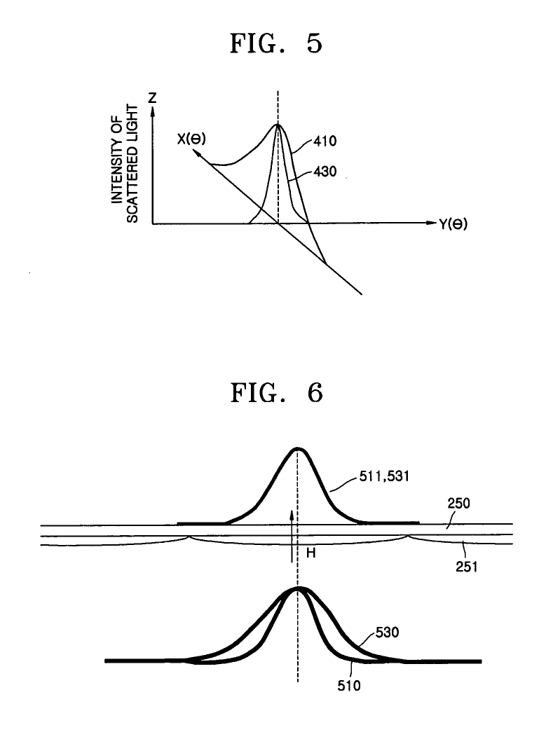

Referring to FIG. 4, an anisotropic light diffusing layer 250 may be formed with elliptical lenses 251 arranged so that their major axes L_{Y} or minor axes L_{X} are parallel with one another. The light diffusing distribution varies according to the geometric shapes of the elliptical lenses 251. For example, in view of the elliptical lenses 251, the light diffusing angular distribution in a direction along the minor axis L_{X} shows a distribution curve of a greater width than the light diffusing angular distribution in a direction along the major axis L_{Y}, as shown in FIG. 5.

More specifically, FIG. 5 is a graph for explaining an anisotropic diffusing characteristic by the elliptical lenses according to an exemplary embodiment of the invention. Referring to FIG. 5, the light incident on the anisotropic light diffusing layer 250 of FIG. 3 having the elliptical lens array is scattered and diffused by the elliptical lenses 251. As discussed above, the geometric characteristics of the elliptical lenses 251 (i.e., the lengths of the major axis L_{Y} and minor axis L_{X} of the lens with respect to the height H of the lens) are different. In view of these differences, a light diffusing angular distribution curve 410 along the minor axis L_{X} with respect to the exit light has a greater width than a light diffusing angular distribution curve 430 along the major axis L_{Y}.

Thus, the adjustment of the light distribution according to an angle of the exit light (i.e., the adjustment of a degree of anisotropic light diffusing) can be implemented by adjusting the lengths of the major axis L_{Y} and the minor axis L_{X} of each of the elliptical lenses 251 with respect to the height H thereof. For example, after the height H of each of the elliptical lenses 251 is set, the lengths of the major axis L_{Y} and the minor axis L_{X} of each of the elliptical lenses 251 can be appropriately set. A regression analysis on luminance may be used for the setting of the height H and the lengths of the major axis L_{Y} and the minor axis L_{X} of each of the elliptical lenses 251.

When the luminance distribution according to an angle with respect to the height of a lens is simulated in a luminance and diffusing angle ray-tracing manner considering FWHM (full width half-maximum), it is anticipated that luminance decreases as the height of the lens increases. Thus, when the height H of a lens is arbitrarily selected to be 10 μm in which a luminance characteristic is high, the diffusing distribution and a degree of change in luminance of exit light are simulated and regression-analyzed according to a ratio R of the height H with respect to the length of the major axis L_{Y} or the minor axis L_{X}, that is, H/(L_{Y} or L_{X}), and the lengths of the major axis L_{Y} and the minor axis L_{X} of an appropriate elliptical lens exhibiting the anisotropic light diffusing characteristic can be set. For example, when the height H of the lens is set to be 10 μm, the lengths of the major axis L_{Y} and the minor axis L_{X} can be set to be about 30 μm through 50 μm and about 6 μm through 8 μm, respectively.

Referring back to FIGS. 4 and 5, the array of the elliptical lenses 251 differently embodies the anisotropic light diffusing characteristic, for example, degrees of light diffusing or light scattering in the X-axis and Y-axis directions. Thus, the light distribution characteristic according to the angle of the exit light exiting from the light diffusing sheet 200 as shown in FIG. 3 can be adjusted by the introduction of the anisotropic light diffusing layer.

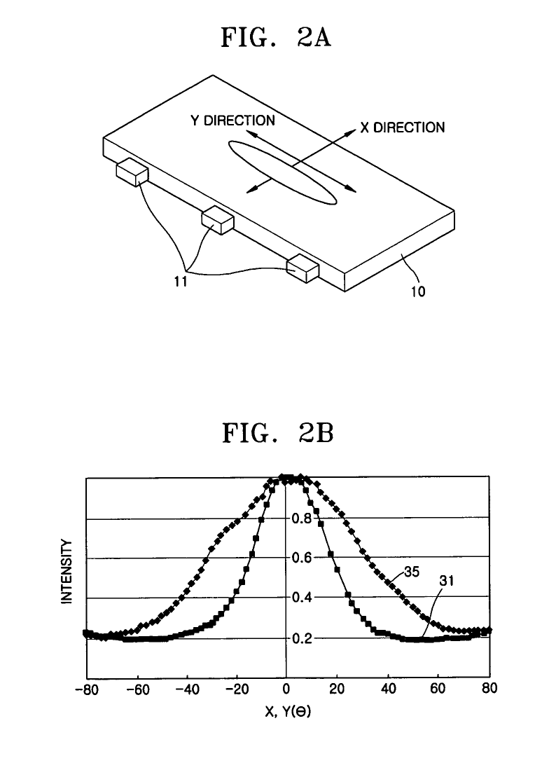

FIG. 6 is a view for explaining the effects of the introduction of the elliptical lens array according to an exemplary embodiment of the invention. Referring to FIG. 6, the effect of the introduction of the anisotropic light diffusing sheet 200 on a light strength distribution characteristic according to the angle of the exit light exiting from the light diffusing sheet 200 is shown. First, as discussed above, the light emitted from the hologram light guide plate 10 may have anisotropic light strength, or the angular distribution of luminance, according to the structural feature of the light guide plate 10. For example, when the grating of the hologram provided at the front surface of the light guide plate 10 is formed in the Y-axis direction perpendicular to the X-axis direction that is the optical-axis direction (e.g., when the grooves of the grating are repeated to extend in the Y-axis direction, as shown in FIG. 2A) the exit light can have an anisotropic light angular distribution in which the light distribution width in the Y-axis direction is greater than that in the X-axis direction.

In this case, the light incident on the anisotropic light diffusing sheet 200 of FIG. 3 provided at the front surface of the light guide plate 10 can have an anisotropic light diffusing angular distribution such that a light diffusing angular distribution curve 510 in the X-axis direction has a narrower width than a light diffusing angular distribution curve 530 in the Y-axis direction, as shown in FIG. 6. The incident light is anisotropically scattered and/or refracted to be anisotropically diffused by the array of the elliptical lenses 251 of the anisotropic light diffusing layer 250 of the light diffusing sheet 200, and thus exits from the front surface of the light diffusing sheet 200.

When the elliptical lenses 251 are arranged such that the direction of the major axis L_{Y} of each of the elliptical lenses 251 is parallel to the X-axis direction that is the optical axis of the light guide plate 10, the incident light is anisotropically scattered due to the anisotropic light diffusing characteristic according to the array of the elliptical lenses 251 as shown in FIG. 5. Accordingly, exit lights 511 and 531 have an isotropic light diffusing angular distribution as shown in FIG. 6, that is, light is emitted that is anisotropically diffused such that the light angular distributions in the X direction and the Y direction are the same. That is, the emitted light can have an isotropic light diffusing angular distribution because the incident light is diffused or scattered at a relatively greater angle in the X direction and at a relatively smaller angle in the Y direction so as to compensate for the anisotropic characteristic of the light guide plate. Thus, luminance and/or visibility according to an angle and the quality of display in a display panel or liquid crystal display panel provided at the front surface of the anisotropic light diffusing sheet 200 can be improved.

As described above, according to the invention, a light diffusing sheet has an anisotropic light diffusing characteristic due to the shape of an elliptical lens provided at the lower surface of the sheet, without using a diffusing material. The distribution of light exiting from the front side forward and backward, and left and right, by the anisotropic light diffusing characteristic can be improved. Also, the quality of display and visibility of a surface illuminant device using the light diffusing sheet can be improved. An additional light sheet, for example, a prism sheet, can be omitted. Since the luminance of a plane display device is improved without providing the prism sheet, assembly is improved and a cost of the surface illuminant device using the optical sheet can be relatively reduced.

While this invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the appended claims.

What is claimed is:

1. A light sheet comprising:
a substrate layer comprising a transparent matrix; and
an anisotropic light diffusing layer comprising an array of elliptical lenses arranged on a first surface of the substrate layer.

2. The light sheet according to claim 1, wherein the anisotropic light diffusing layer anisotropically scatters light input thereto before transmitting the light to the substrate layer.

3. The light sheet according to claim 1, wherein the elliptical lenses are convex.

4. The light sheet according to claim 1, wherein lengths of major and minor axes of each of the elliptical lenses are set such that light diffusing angular distributions in directions along the major axis and the minor axis are different from each other.

5. The light sheet according to claim 1, wherein the elliptical lenses of the anisotropic light diffusing layer are arranged parallel to one another in the direction along the major axis or the minor axis of each elliptical lens.

6. The light sheet according to claim 1, wherein the elliptical lenses of the anisotropic light diffusing layer are engraved on a surface of the substrate layer.

7. The light sheet according to claim 1, further comprising an isotropic light diffusing layer formed on a second surface of the substrate layer opposite the first surface.

8. A light sheet comprising:
a substrate layer comprising a transparent matrix; and
an anisotropic light diffusing layer comprising an array of elliptical lenses engraved on a first surface of the substrate layer.

9. The light sheet according to claim 8, wherein the anisotropic light diffusing layer anisotropically scatters light input thereto before transmitting the light to the substrate layer.

10. The light sheet according to claim 8, wherein the elliptical lenses are convex.

11. The light sheet as claimed in claim 8, wherein lengths of major and minor axes of each of the elliptical lenses are set such that light diffusing angular distributions in directions along the major axis and the minor axis are different from each other.

12. The light sheet as claimed in claim 8, wherein the elliptical lenses of the anisotropic light diffusing layer are arranged parallel to one another in the direction along the major axis or the minor axis of each elliptical lens.

13. The light sheet according to claim 8, further comprising an isotropic light diffusing layer deposited on a second surface of the substrate layer opposite the first surface.

14. A surface illuminant device comprising:
a light source;
a light guide plate that guides light generated from the light source; and
a light sheet on the light guide plate, the light sheet comprising: a substrate layer comprising a transparent matrix; and an anisotropic light diffusing layer comprising an array of elliptical lenses arranged on a first surface of the substrate layer.

15. The surface illuminant device according to claim 14, wherein the anisotropic light diffusing layer anisotropically scatters light input thereto from the light guide plate before transmitting the light to the substrate layer.

16. surface illuminant device according to claim 14, wherein the elliptical lenses of the anisotropic light diffusing layer are convex.

17. The surface illuminant device according to claim 14, wherein lengths of major and minor axes of each of the elliptical lenses are set such that light diffusing angular distributions in directions along the major axis and the minor axis are different from each other.

18. The surface illuminant device according to claim 14, wherein the elliptical lenses of the anisotropic light diffusing layer are arranged parallel to one another in the direction along the major axis or the minor axis of each elliptical lens.

19. The surface illuminant device according to claim 14, wherein the elliptical lenses of the anisotropic light diffusing layer are engraved on a surface of the substrate layer.

20. The surface illuminant device according to claim 14, wherein the light diffusing sheet further comprises an isotropic light diffusing layer formed on a second surface of the substrate layer opposite the first surface.

21. The surface illuminant device according to claim 14, wherein:
the light source is arranged on a side of the light guide plate, and has an optical axis extending in a first direction; and
the elliptical lenses have parallel long axes arranged in a direction perpendicular to the first direction.

22. The surface illuminant device according to claim 14, wherein:
the light guide inputs first anisotropically scattered light to the anisotropic light diffusing layer;
the anisotropic light diffusing layer anisotropically scatters the first anisotropically scattered light input thereto in such a manner that the light output into the substrate layer is isotropic.
